(19) United States
(12) Patent Application Publication
(10) Pub. No.: US 2002/0124494 A1
(43) Pub. Date: Sep. 12, 2002

(54) Molded frame construction

(75) Inventor: Vic De Zen, Woodbridge (CA)

Correspondence Address: Douglas S. Johnson, Suite 301, 133 Richmond Street West, Toronto, ON, M5H 2L7, CA

(73) Assignee: Royal Group Technologies Limited

(21) Appl. No.: 09/735,498

(22) Filed: Dec. 14, 2000

(30) Foreign Application Priority Data
Dec. 15, 1999 (CA) 2.292.209

(51) Int. Cl. E06B 1/04

(52) U.S. Cl. 52/204.1

(57) ABSTRACT

One piece integrally molded frame members that fit against each other to form a support frame having an article retaining recess therein.

### FIELD OF THE INVENTION

This invention relates to frames such as sashes for retaining panes of glass or glazing units or the like and to frames in which such sashes including slidable sashes are mounted.

### BACKGROUND OF THE INVENTION

To support a pane of glass or a glazing unit, or a panel or the like in a frame the frame when assembled presents spaced sides defining a retaining channel or recess therebetween to receive the edges of the glass pane or unit or panel and hold it in place.

Conventionally such frames whether formed from wood or aluminum or plastic extrusions are assembled from cut lengths of material cut to form the sides, top and bottoms of the frames. After cutting these various lengths of material are then mitered or otherwise trimmed and then assembled and secured together by mechanical fasteners, welding or other fastening means into the requisite frame having spaced sides and defining a retaining channel or recess therebetween.

The cutting, mitering and assembly of the various frame members or components making up the frame requires very considerable time and skill so that the cost of producing the frames is relatively high and it is difficult to maintain consistent, precise frame dimensions and secure connections between the various components.

It is the object of the present invention to greatly reduce the cost of constructing such frames as aforesaid and to provide such frames which not only have precise accuracy in all details but are extremely strong. More particularly, the invention is directed to providing frames of moldable material, especially frames of moldable plastic material although the invention is also applicable to other moldable materials such as aluminum.

### SUMMARY OF THE INVENTION

In accordance with the invention, there is provided first and second integrally molded one piece frame members that fit against one another to form a support frame having a recess therein to retain a pane of glass, a glazing unit, a fixed window sash, the shoes of a sliding glass sash or other article.

More particularly, such first and second one piece molded frame members are configured to form opposite sides of the frame with at least one of the frame members having an integral laterally projecting peripheral wall which spaces the opposite sides from one another when the frame members are brought together and which defines a retaining recess therebetween.

The invention further encompasses of the use of a first, second and third frame members each having a one piece molded construction configured to form a side of a frame with one of said frame members being an intermediate frame member located between the other two frame members, that the intermediate frame member being formed to constitute one side of a frame with each of the other two frame members, the arrangement being such that said frame members between them provide lateral peripheral walls spanning between and spacing the intermediate frame member and the opposing frame members to provide an article retaining recesses between the intermediate frame member and each of the opposing frame members.

In this connection the invention also encompasses a frame structure in which an intermediate one piece molded frame member and an outer one piece molded frame member fitted to one side of the intermediate frame member have inturned peripheral extending lips or flanges at their inner perimeters to overlie the article retaining recesses but having a space therebetween at least one of the lips or flanges forming a guide surface for a sliding sash while the retaining recesses receives the conventional shoes pivotally connected to the bottom of the sliding sash while the pivot arms of the shoes and the retractable upper sash guides extend through space between the lips or flanges.

Preferably the molded frame members of the invention are formed from a moldable plastic material including any such material in which particles of filler or waste material are incorporated into the plastic.

In accordance with the invention, the frames formed from such one piece molded frame members configured to form opposite sides of the frame may have such frame members connected face to face by mechanical fasteners or they may be formed to be interlock together for simplification of assembly.

These and other features of the invention will become apparent from the following detailed description taken in conjunction with the accompanying drawings.

### BRIEF DESCRIPTION OF THE DRAWINGS

These and other features of the invention will become apparent from the following detailed description taken in conjunction with the accompanying drawings in which

FIG. 1 is a perspective view of a window unit having an outer frame embodying the invention as well as a slidable window sash and a fixed window sash also embodying the invention;

FIG. 2 is an exploded perspective view of the window unit of FIG. 1 looking in from the outside of the window unit;

FIG. 3 is an exploded perspective view looking towards the window unit from the inside with the slidable window sash removed;

FIG. 4 is a horizontal cross-section of the components of the window unit of FIG. 1 in separated relationship about to be assembled together;

FIG. 5 is a horizontal sectional view showing the separated components of FIG. 4 assembled together into the window unit;

FIG. 6 is a horizontal sectional view similar to FIG. 5 but showing a window unit in which both the lower and upper sashes are slidable;

FIG. 7 is a horizontal cross-sectional view of a simple window sash formed of two integrally molded frame members press fitted together into interengaging relationship to retain the glazing unit within the retaining recess or channel formed on assembly of the two frame members.

### DETAILED DESCRIPTION ACCORDING TO THE PREFERRED EMBODIMENTS OF THE PRESENT INVENTION

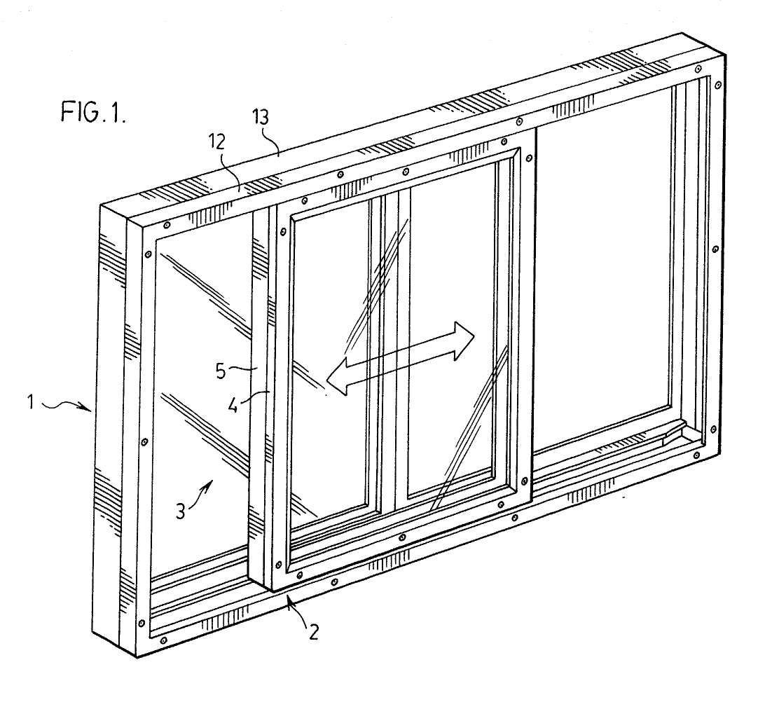

With reference to FIG. 1, the window unit disclosed has an outer main frame generally designated at 1, a slidable lower window sash generally designated at 2, and a fixed upper window sash generally designated at 3.

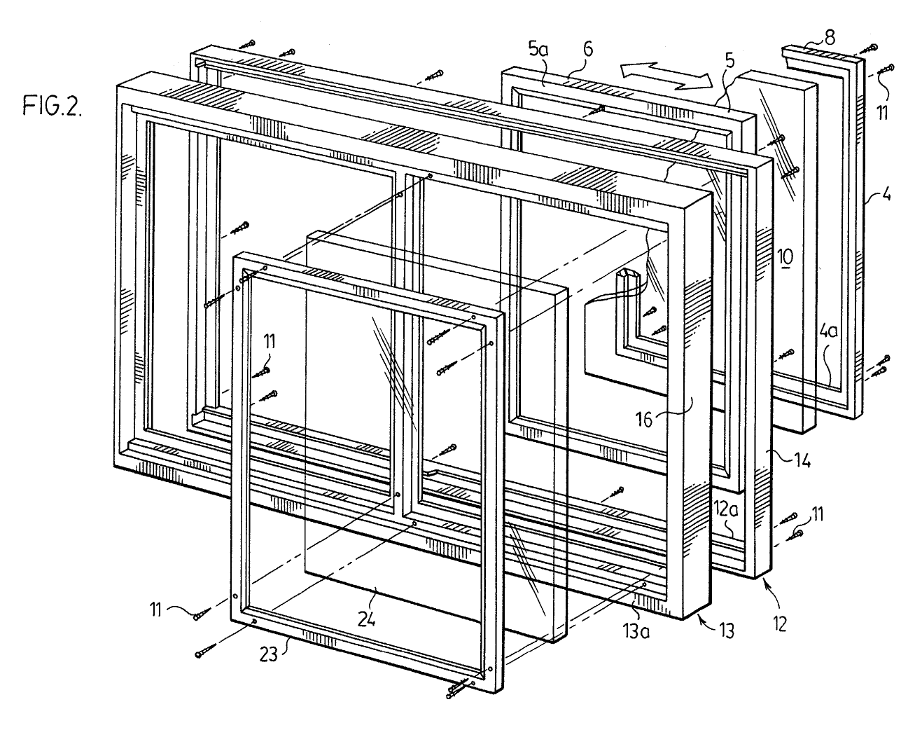

Considering first the sliding lower window sash 2, as illustrated in FIGS. 1, 2, 4 and 5, this sash comprises two integrally molded one piece rectangular frame members 4 and 5. The frame member 5 has a laterally extending peripheral wall 6 from which project outwardly extending guide members 7 which may, for instance, be retractable locking devices (not shown). Frame member 4 has a very short laterally extending peripheral wall 8. These two integrally molded frame members 4 and 5 are formed to be brought together face to face with the peripheral walls 6 and 8 in contact with each other while spacing the rectangular side walls 4a and 5a of frames 4 and 5 respectively to provide a perimeteral groove or recess 9 between the side walls 4a and 4b to receive a pane of glass or glazing unit 0. Suitable fasteners 11 are used to secure the frame members 4 and 5 together to retain the glazing unit 10 in the groove or recess 9.

It will be noted that the peripheral wall 8 of the frame member 5 extends slightly beyond peripheral wall 6 of frame member 5 to form a sliding bearing surface as hereinafter more particularly explained.

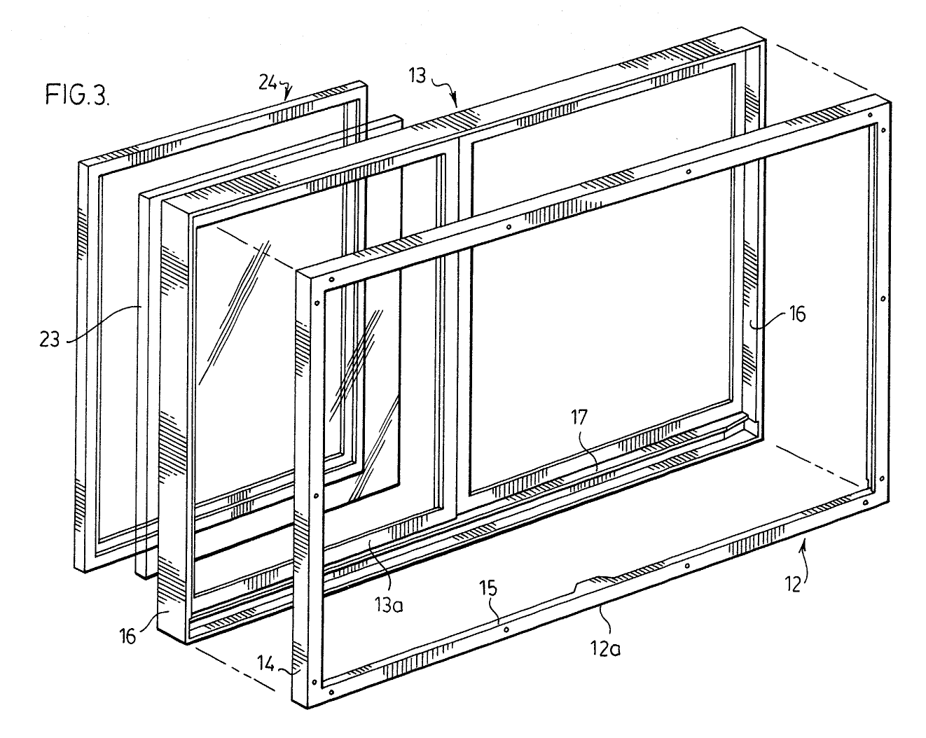

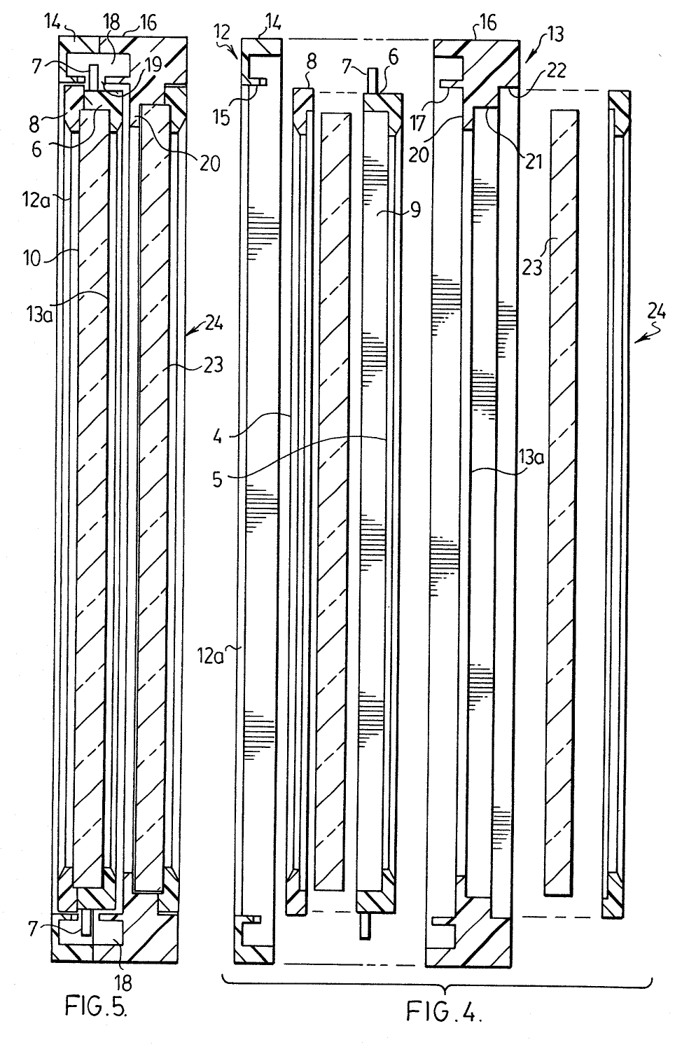

The main outer frame 1, as shown in FIGS. 1, 2 and 3, and particularly in FIGS. 4 and 5, again comprises two integrally molded rectangular one piece frame members 12 and 13.

The frame member 12 has a laterally projecting peripheral wall 14 extending around the outer perimeter thereof and spaced inwardly therefrom, a second laterally projecting continuous lip or flange 15 having a lateral extent less than wall 14 extending around the frame member 12.

The integrally molded one piece frame member 13 of the main frame 1 is also provided with a continuous peripheral wall 16 extending around the perimeter thereof and spaced inwardly therefrom, a second shorter laterally projecting continuous lip or flange 17 having a lateral extent less than wall 16.

As illustrated particularly in FIG. 5, when the main frame integrally molded frame members 12 and 13 are brought together face to face to form the frame, the walls 14 and 16 abut to hold the frame side walls 12a and 13a of frame member 12 and 13 respectively in spaced relation to define a recess or channel 18 between side walls 12a and 13a extending around the interior of what is now the outer main frame 1.

As shown in FIG. 5, when the main frame members 12 and 13 are assembled, the shorter laterally projecting lips or flanges 15 and 17 overlie the channel 18 but leave a gap 19 therebetween.

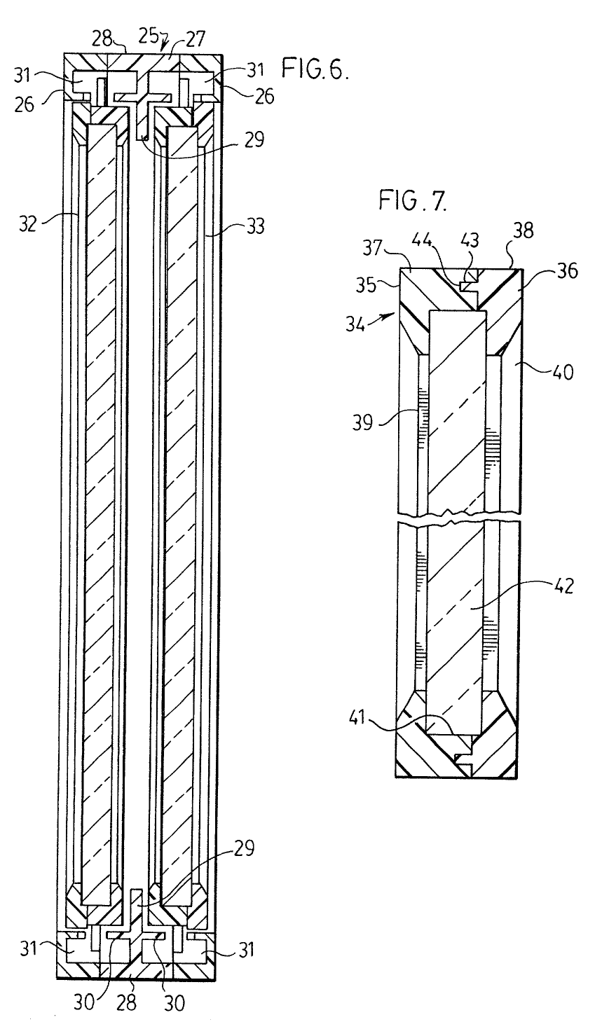

As illustrated, particularly in FIGS. 5 and 6, the integrally molded main frame member 13 has a portion 20 of its sidewall 13a which projects inwardly beyond its laterally extending lip or flange 17 to form a stop for the sliding lower window sash 2. The peripheral lip or flange 15 of the one piece frame member 12 provides a bearing surface on which the slightly projecting peripheral wall 8 of the frame member 4 of the sash 2 rides as it slides up and down in the main frame.

The sliding sash 2 is retained in the main frame by the guide 5 members 7 carried thereby which project through the gap 19 into the channel 18.

It will be understood that the sliding sash 2 will have its lower end pivotally connected to the usual retaining shoes (not shown) which slide in the channel formation 18 provided at each side of the main frame 1.

As shown particularly in FIGS. 5 and 6, the side wall 13a of the one piece main frame 13 has the portion 20 which extends inwardly of the lip or flange 17 formed with steps 21 and 22. The step 21 in conjunction with the inwardly projecting wall portion 20, in addition to forming a stop for the lower sliding sash 2, now forms one side of a frame to receive the glazing unit 23 of the fixed upper sash 3 while the second step 22 provides a recess to receive a further integrally molded one piece rectangular frame member 24 which forms the other side of the fixed upper window sash 3. Again suitable fasteners 11 secure the integrally molded frame members 13 and 24 in assembled glazing unit retaining relationship.

It will thus be appreciated that the integrally molded frame member 13 functions as both one side of the main frame 1 which houses the slidable lower window sash 2 and also one side of the fixed upper sash 3. The result is that the entire window unit requires only the assembly of five integrally molded one piece frame members, the two integrally molded main frame members 12 and 13, the two sliding lower window sash frame members 4 and 5, and the single further fixed upper sash frame member 24. 30

Because the frame members are injection or compression molded, they can be formed with precision accuracy, with predetermined uniform strength, and without joints or inconsistent dimensions. On completion they are ready for quick and accurate assembly.

FIG. 6 shows the application of the invention to a window unit having sliding upper and lower sashes. In this case, the main frame generally designated at 25 comprises a pair of outer one piece integrally molded rectangular frame members 26 each corresponding to the frame member 12 in FIGS. 4 and 5. The intermediate main frame member 27 which again is a one piece integrally molded rectangular frame member is provided with a peripheral wall 28 and a central leg 29 extending inwardly from the peripheral wall 28 in the form of a cross with the lateral arms 30 of the cross forming with the frame members 26 the retaining recesses or channels 31 corresponding to the channel 18 of FIGS. 4 and 5 while the inwardly projecting lower end of the cross 29 forms the stop for the sliding window sashes 32 and 33 which correspond in all respects to the sliding window sash 2 as described above.

FIG. 7 is a cross sectional view of a single window sash 34 formed simply of two integrally molded one piece frame members 35 and 36 having peripheral walls 37 and 38 which meet when the frame members 35 and 36 are brought together to hold the side walls 39 and 40 of the frames 35 and 36 respectively in spaced relation and to define a recess or channel 41 to retain a glazing unit 42.

In the case of the frames of 35 and 36 of FIG. 7, the peripheral wall 38 of the frame 36 is formed with an integral projecting formation 43 which tightly engages in a groove formation 44 in the frame member 35 to hold same together eliminating or minimizing the use of mechanical fasteners.

It will be understood that although the various illustrations show the frame members as rectangular the frame members can be molded into any particular perimeteral shape such as circular, octagonal and the like whereby the article to be retained is captured within a retaining recess using only two integrally molded frame members. It will also be understood that various modifications may be made to the frame members without departing from the scope of the appended claims.

The embodiments of the invention in which an exclusive property or privilege is claimed are defined as follows:

1. First and second one piece integrally molded area circumscribing frame members that fit against one another to form an area circumscribing support frame having an article retaining recess therein.

2. One piece integrally molded frame members as claimed in claim 1 in which at least one of said members has an integral laterally projecting peripheral wall extending around the perimeter thereof against which the other frame member fits to form said article retaining recess.

3. One piece integrally molded frame members as claimed in claim 1 in which both of said frame members have laterally projecting peripheral walls extending around their outer perimeters which abut when said frame members are fitted together to define said article retaining recess.

4. One piece integrally molded frame members as claimed in claim 2 or 3 in which both of said frame members have at their inner perimeters integral laterally projecting lips which, upon said members being fitted together, face each other with a space therebetween to form a slotted wall overlying at least a portion of said article retaining recess.

5. One piece integrally molded frame members as claimed in claim 1, 2 or 3 in which said members are injection molded plastic members.

6. One piece integrally molded frame members as claimed in claim 1, 2 or 3 in which said members are compression molded plastic members.

7. One piece integrally molded frame members framed in claim 1 in which each of said members is one side of a window sash and said retaining recess is adapted to retain a glazing unit.

8. One piece integrally molded frame members as claimed in claim 4 in which said members form the sides of a frame to support a sliding window sash.

9. One piece integrally molded frame members as claimed in claim 1 in which at least one of said frame members is further formed to fit against a third one piece integrally molded area circumscribing frame member to form a second support frame having an article retaining recess therein.

10. First and second frame members as claimed in claim 1 configured to form on assembly face to face one side of a window frame, at least one of said frame members having at the outer perimeter thereof a laterally projecting wall which spaces said frame members from one another and defines a window unit retaining channel.

11. Frame members as claimed in claim 10 having at least over a portion of their inner perimeters integral inwardly projecting lips having a width less than half the spacing between said frame members when same are assembled face to face.

12. First and second frame members as claimed in claim 10 or 11 in combination with a third one piece molded area circumscribing rectangular frame member configured for assembly with one of said first and second frame members at one side thereof opposite to said side forming said retaining recess to form an adjoining frame having a window retaining recess therein.

13. First and second frame members as claimed in claim 1 formed to be brought together face to face to form the sides of a window sash with a glazing unit retaining recess therebetween, a glazing unit located between said sash sides received in said retaining recess and means securing said molded frame members together to retain said glazing unit therebetween.

14. A window unit as claimed in claim 13 in which said frame members are formed to interengage when in registration.

15. First and second frame members as claimed in claim 1 each configured to form opposite sides of a sliding window unit frame, at least one of said frame sides having an integral laterally projecting wall at its outer perimeter which spaces said opposite frame sides from one another when same are assembled, and both said one piece frame members having at their inner perimeters an integral lip having a width less than one half the spacing of said frame members when same are assembled, said lips projecting inwardly of said frame members when assembled to provide retaining walls overhanging at least a portion of said retaining channel, said retaining walls having a space therebetween providing access to said retaining channel.

16. A window unit as claimed in claim 15 in combination with a third rectangular frame member of one piece molded construction configured to form with one of the aforesaid frame members a second frame in which said one of said frame members forms one side thereof with said third frame member.
